(19) United States
(12) Patent Application Publication
(10) Pub. No.: US 2020/0212764 A1
(43) Pub. Date: Jul. 2, 2020

(54) POWER GENERATOR

(71) Applicant: HONDA MOTOR CO., LTD., Tokyo (JP)

(72) Inventor: Katsutoshi Matsushita, Wako-shi (JP)

(21) Appl. No.: 16/597,044

(22) Filed: Oct. 9, 2019

(30) Foreign Application Priority Data
Dec. 28, 2018 (JP) 2018-248226

(51) Int. Cl. H02K 7/18; H02K 9/22; H02K 5/24; F02B 63/04; F02M 37/00

(52) U.S. Cl. CPC H02K 7/1815; H02K 9/22; H02K 5/24; F02B 2063/046; F02M 37/0076; F02M 37/0011; F02B 63/048

(57) ABSTRACT

The power generator includes: an alternator for generating electricity by driving an engine; an inverter case containing an inverter circuit of the alternator; a fuel tank for storing a fuel to be supplied to the engine; and a casing for housing at least the engine, the alternator and the inverter case, wherein the inverter case and the fuel tank are formed of a material having higher thermal conductivity than the casing, and the inverter case is disposed in contact with the fuel tank.

### INCORPORATION BY REFERENCE

The present application claims priority under 35 U.S.C. § 119 to Japanese Patent Application No. 2018-248226 filed on Dec. 28, 2018. The content of the applications is incorporated herein by reference in its entirety.

### BACKGROUND OF THE INVENTION

### Field of the Invention

The present invention relates to a soundproof power generator including an engine, etc. housed in a casing.

### Description of the Related Art

As a power generator, a soundproof power generator including an engine, etc., housed in a casing has been known (see, for example, Japanese Patent Application Laid-Open No. 2008-282581).

In general, a power generator includes an alternator for generating electricity by driving an engine, an inverter case containing an inverter circuit of the alternator, and a fuel tank for storing a fuel to be supplied to the engine.

The soundproof power generator houses all the structures, such as the engine, in the casing so that sound in generating electricity is unlikely transmitted to the outside of the casing.

Moreover, in the soundproof power generator, since the inverter case is housed in the casing together with the engine and the alternator as heat sources, the temperatures of the inverter case and the inverter circuit contained in the inverter case rise due to the heat of the engine, etc. when generating electricity. The higher the temperature, the higher the electrical resistance value in the inverter circuit.

Therefore, in the soundproof power generator, a heat dissipation fin is provided on a surface of the inverter case, and an air flow path is provided in the casing so that the air taken in from the outside of the casing is brought into contact with the heat dissipation fin.

The air flow path is a gap provided between the heat dissipation fin and the fuel tank, between the inverter case and the fuel tank, or the like.

### SUMMARY OF THE INVENTION

For the soundproof power generator, there are demands for downsizing of the power generator and increasing the capacity of the fuel tank.

However, if downsizing of the power generator and an increase in the capacity of the fuel tank proceed, it is difficult to secure the air flow path, and therefore a more efficient heat dissipation measure is required for the inverter case.

The present invention was made in view of such circumstances, and it is an object of the present invention to provide a power generator capable of efficiently dissipating heat of the inverter case.

In order to achieve the above object, an aspect of the present invention includes: an alternator for generating electricity by driving an engine; an inverter case containing an inverter circuit of the alternator; a fuel tank for storing a fuel to be supplied to the engine; and a casing for housing at least the engine, the alternator and the inverter case, wherein the inverter case and the fuel tank are formed of a material having higher thermal conductivity than the casing, and the inverter case is disposed in contact with the fuel tank.

According to the aspect of the present invention, the inverter case and the fuel tank are formed of a material having higher thermal conductivity than the casing, and the inverter case is disposed in contact with the fuel tank, and therefore the heat of the inverter case can be easily transferred to the fuel tank and dissipated in the fuel tank. In addition, since the surface area of the fuel tank is generally larger than the surface area of the inverter case, the dissipation of heat of the inverter case can be more efficiently performed.

In the above configuration, at least a part of the fuel tank is exposed to the outside of the casing.

According to the aspect of the present invention, since the heat transferred to the fuel tank is easily dissipated to the outside of the casing, the dissipation of heat of the inverter case can be more efficiently performed.

In the above configuration, a recessed portion is formed at a lower portion of the fuel tank, and the inverter case is disposed in the recessed portion.

According to the aspect of the present invention, the inverter case and the fuel tank can be integrated into a unit. Accordingly, holder parts that hold the inverter case and the fuel tank, respectively, can be integrated, thereby allowing downsizing and a reduction in weight of the power generator, and an increase in the capacity of the fuel tank.

In the above configuration, a gutter for guiding the fuel not to flow into the inverter case is provided at a portion of the fuel tank located inside the casing.

According to the aspect of the present invention, since the surface area involved in heat dissipation is increased by an amount corresponding to the gutter, the heat dissipation efficiency can be improved.

In the above configuration, a portion of the fuel tank located inside the casing is formed to have a greater plate thickness than other portions.

According to the aspect of the present invention, the fuel tank can be made a part of a frame of the casing, thereby simplifying the frame structure. Also, the heat of the inverter case can be efficiently transferred to the entire fuel tank.

In the above configuration, a recess and a protrusion are formed at a portion of the fuel tank located outside the casing.

According to the aspect of the present invention, since the surface area of the fuel tank is increased by the recess and the protrusion, the heat dissipation efficiency can be improved. Further, it is possible to improve the design by the recess and the protrusion.

According to the aspect of the present invention, the inverter case is in contact with the fuel tank, and the inverter case and the fuel tank are formed of a material having higher thermal conductivity than the casing, and therefore the heat of the inverter case can be easily transferred to the fuel tank and dissipated in the fuel tank. As a result, heat dissipation fins which are conventionally mounted on the surface of the inverter case can be made smaller or eliminated, thereby allowing downsizing of the power generator and an increase in the capacity of the fuel tank. Furthermore, a gap (air flow path) which is conventionally provided between the inverter case and the fuel tank is no longer needed, thereby allowing downsizing of the power generator and an increase in the capacity of the fuel tank.

### BRIEF DESCRIPTION OF THE DRAWINGS

FIG. 1 is a perspective view showing a first embodiment of a power generator according to the present invention;

FIG. 2 is a perspective view of the power generator of the first embodiment as viewed from a direction different from the direction in FIG. 1;

FIG. 3 is a cross-sectional view of the power generator of the first embodiment;

FIG. 4 is a cross-sectional view of a fuel tank of the power generator of the first embodiment; and

FIG. 5 is a perspective view showing a second embodiment of a power generator according to the present invention.

### DETAILED DESCRIPTION OF THE PREFERRED EMBODIMENTS

Hereinafter, an embodiment of the present invention will be described with reference to the drawings.

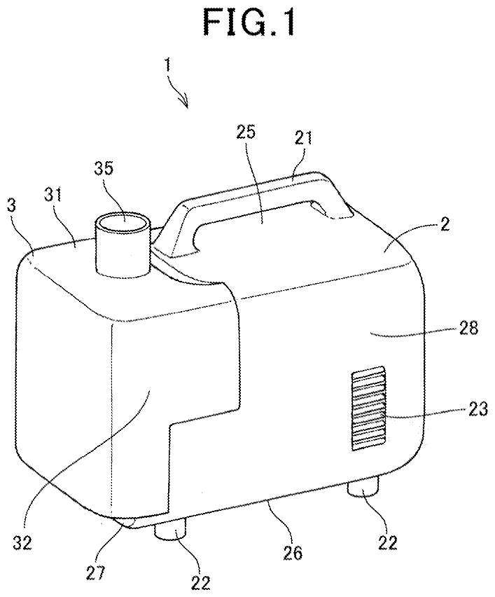

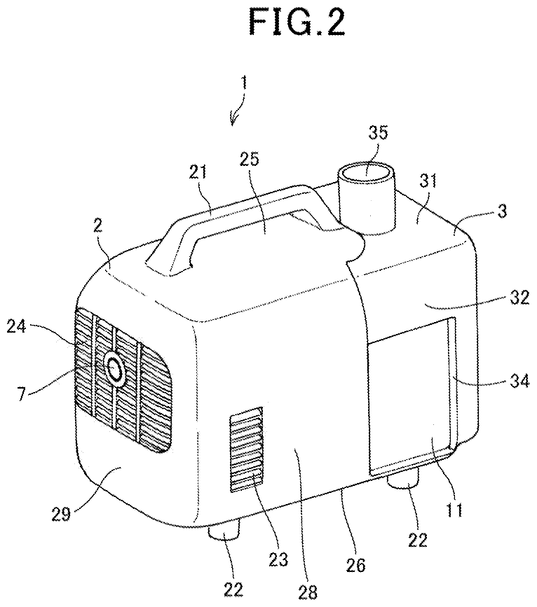

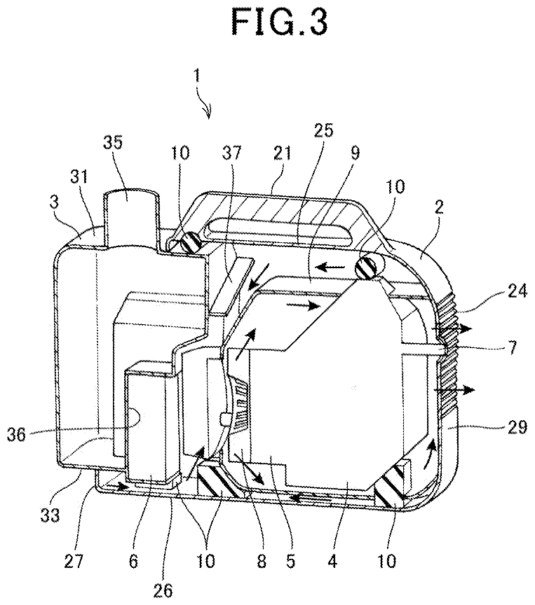

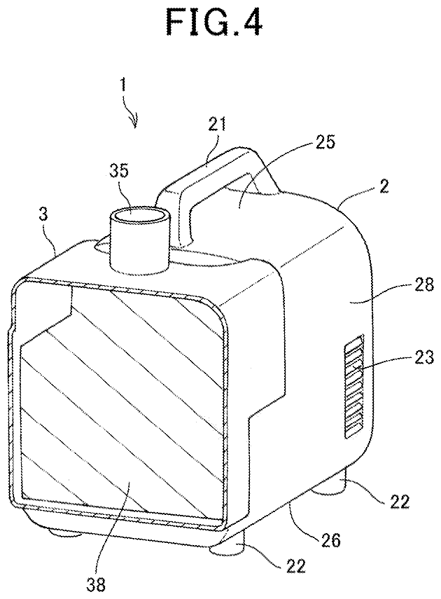

FIG. 1 and FIG. 2 are perspective views showing the appearance of a power generator of the first embodiment. FIG. 3 is a cross-sectional view of the power generator. FIG. 4 is a cross-sectional view of a fuel tank of the power generator.

As shown in FIG. 1 and FIG. 2, a power generator 1 includes a casing 2 and a fuel tank 3 partially exposed to the outside of the casing 2, and, as shown in FIG. 3, an engine 4, an alternator 5, and an inverter case 6 are housed in the casing 2.

The casing 2 is made of resin, and, as shown in FIG. 3, is formed in a substantially rectangular parallelepiped shape with a front side (left side in FIG. 3) being open. As shown in FIG. 1 and FIG. 2, a handle 21 is formed on a top plate 25 of the casing 2, and a plurality of legs 22 are attached to a bottom plate 26. Moreover, intake openings 23 are formed in a lower portion of a front plate 27 of the casing 2 (on the lower side of the fuel tank 3) and in a pair of opposite side plates 28, and an exhaust opening 24 is formed in a rear plate 29. The intake opening in the lower portion of the front plate 27 is not shown in the drawings.

The fuel tank 3 stores a fuel to be supplied to the engine 4. Further, as shown in FIG. 3, the fuel tank 3 constitutes a part of the casing 2 in a state in which the fuel tank 3 closes a front side of the casing 2. A portion (hatched portion 38 in FIG. 4) of the fuel tank 3 located inside the casing 2 has a greater plate thickness than other portions. As shown in FIG. 1 and FIG. 2, a pair of opposite side plates 32 of the fuel tank 3 are formed to be flush with the side plates 28 of the casing 2.

At a portion of one of the side plates 32 of the fuel tank 3 exposed to the outside of the casing 2, as shown in FIG. 2, a rectangular first recessed portion 34 for disposing an operation panel 11 is formed. Moreover, a cylindrical fuel fill opening 35 is formed integrally with the top plate 31 of the fuel tank 3 in a state in which the cylindrical fuel fill opening 35 protrudes upward.

In a portion of the fuel tank 3 located inside the casing 2, as shown in FIG. 3, a rectangular second recessed portion 36 for disposing the inverter case 6 is formed at a lower portion. Further, on a rear surface of the fuel tank 3 located inside the casing 2, a plate-like gutter 37 for guiding the fuel leaked from the fuel fill opening 35 not to flow into the inverter case 6 is provided integrally with the fuel tank 3.

The material of the fuel tank 3 and the gutter 37 has higher thermal conductivity than the material (resin) of the casing 2, and, examples of the material include metals. Among metals, iron, aluminum, and aluminum alloys are practical.

The engine 4 is disposed on the rear side (exhaust opening 24 side) in the casing 2 so that an output shaft (not shown) extends in a front-rear direction. The output shaft protrudes toward the front of the engine 4. Furthermore, on the rear side of the engine 4, a muffler 7 extending to the exhaust opening 24 is provided.

The alternator 5 is coaxially connected to the output shaft protruding toward the front of the engine 4. Moreover, a fan 8 is coaxially attached to the output shaft in front of the alternator 5.

The inverter case 6 is formed in a substantially rectangular parallelepiped shape, and is installed in the second recessed portion 36 of the fuel tank 3. The top surface and front surface of the inverter case 6 are closely attached to the top surface and rear surface of the second recessed portion 36. Consequently, most of the front surface and top surface of the inverter case 6 are in contact with the second recessed portion 36. The inverter case 6 contains an inverter circuit of the alternator 5, and is disposed in front of the fan 8 with a distance between the alternator 5 and the fan 8.

The material of the inverter case 6 has higher thermal conductivity than the material (resin) of the casing 2, and, examples of the material include metals. Among metals, iron, aluminum, and aluminum alloys are practical.

Moreover, a shroud 9 which covers from a peripheral portion of the fan 8 to the alternator 5, the engine 4 and the muffler 7 is provided in the casing 2.

Furthermore, a plurality of rubber mounts 10 for sound insulation and vibration insulation are provided in the casing 2. The rubber mounts 10 are disposed between a front root portion of the handle 21 on the top portion of the casing 2 and a portion where the top plate 31 of the fuel tank 3 is not exposed, between a rear root portion of the handle 21 and the top portion of the engine 4, between a bottom plate 33 of the fuel tank 3 and the bottom plate 26 of the casing 2 corresponding to the position of the inverter case 6 in the lower portion of the casing 2, between a front lower portion of the shroud 9 and the bottom plate 26 of the casing 2, and between a rear lower portion of the engine 4 and the bottom plate 26 of the casing 2.

The operation panel 11 is disposed in the first recessed portion 34 formed in the fuel tank 3. The operation panel 11 is provided with an electrical outlet and operation buttons (not shown).

Next, the functions of the present embodiment will be described.

In the power generator 1 having such a configuration, when generating electricity, the air flows as follows (see arrows in FIG. 3).

When generating electricity, the output shaft of the engine 4 is rotationally driven by starting the engine 4. Consequently, electricity is generated by the alternator 5, and the fan 8 is rotated. With the rotation of the fan 8, outside air is taken into the casing 2 from the intake openings 23. Then, the air from the intake openings 23 formed in a pair of side plates 28 of the casing 2 flows outside the shroud 9 toward the fan 8 along the shroud 9. At this time, the air flows in contact with the rear surface of the fuel tank 3 located inside the casing 2 and the inverter case 6. The air from the intake opening formed in the lower portion of the front plate 27 of the casing 2 flows in contact with the bottom plate 33 of the fuel tank 3 located inside the casing 2 and the inverter case 6 toward the fan 8. A part of the air that has passed through the fan 8 is taken into the engine 4 and used for fuel combustion, and then discharged from the muffler 7, and the remaining air is taken into and passes through an internal space enclosed by the shroud 9 with the rotation of the fan 8 and is then discharged from the exhaust opening 24.

When generating electricity, since the engine 4 and the alternator 5 generate heat, the temperature inside the casing 2 rises, and accordingly the temperatures of the inverter case 6 and the inverter circuit contained in the inverter case 6 also rise.

However, since the air taken from outside contacts the surfaces of the inverter case 6, the alternator 5 and the engine 4 because of the above-mentioned flow of air, an excessive temperature rise in the inverter case 6 and the inverter circuit is prevented.

Further, in the power generator 1 of the first embodiment, the inverter case 6 is in contact with the fuel tank 3, a part of the fuel tank 3 is exposed to the outside of the casing 2, and the material of the inverter case 6 and the fuel tank 3 has high thermal conductivity. Therefore, the heat of the inverter case 6 is easily transferred to the fuel tank 3, and the heat transferred to the fuel tank 3 is easily dissipated to the outside. That is, the fuel tank 3 functions as a heat sink for heat dissipation for the inverter case 6. Therefore, it is possible to further prevent a rise in temperature of the inverter case 6.

Consequently, the excessive temperature rise in the inverter circuit contained in inverter case 6 can also be prevented, and the excessive rise in the electrical resistance value can be prevented. As a result, power conversion by the inverter circuit can be properly performed.

As described above, the present embodiment includes the alternator 5 for generating electricity by driving the engine 4, the inverter case 6 containing the inverter circuit of the alternator 5, the fuel tank 3 for storing the fuel to be supplied to the engine 4, and the casing 2 for housing at least the engine 4, the alternator 5 and the inverter case 6, wherein the inverter case 6 and the fuel tank 3 are formed of a material having higher thermal conductivity than the casing 2, and the inverter case 6 is disposed in contact with the fuel tank 3.

Therefore, the heat of the inverter case 6 can be easily transferred to the fuel tank 3, and can be dissipated in the fuel tank 3. In addition, since the surface area of the fuel tank 3 is generally larger than the surface area of the inverter case 6, the dissipation of heat of the inverter case 6 can be more efficiently performed.

As a result, heat dissipation fins which are conventionally mounted on the surface of the inverter case 6 can be made smaller or eliminated (eliminated in the drawings), thereby allowing downsizing of the power generator 1 and an increase in the capacity of the fuel tank 3. Furthermore, a gap (air flow path) which is conventionally provided between the inverter case 6 and the fuel tank 3 is no longer needed, thereby allowing downsizing of the power generator 1 and an increase in the capacity of the fuel tank 3.

Moreover, in the present embodiment, at least a part of the fuel tank 3 is exposed to the outside of the casing 2.

Thus, since the heat transferred to the fuel tank 3 is easily dissipated to the outside of the casing 2, the dissipation of heat of the inverter case 6 can be more efficiently performed.

Further, in the present embodiment, the second recessed portion 36 is formed in the lower portion of the fuel tank 3, and the inverter case 6 is disposed in the second recessed portion 36.

Thus, the inverter case 6 and the fuel tank 3 can be integrated into a unit. Accordingly, holder parts that hold the inverter case 6 and the fuel tank 3, respectively, can be integrated, thereby allowing downsizing of the casing 2. As a result, the power generator 1 can be downsized and the capacity of the fuel tank 3 can be increased.

Furthermore, in the present embodiment, the gutter 37 for guiding the fuel not to flow into the inverter case 6 is provided at a portion of the fuel tank 3 located inside the casing 2.

Thus, since the surface area involved in heat dissipation is increased by an amount corresponding to the gutter 37, the heat dissipation efficiency can be improved. In addition, since the gutter 37 can prevent the fuel from flowing into the inverter case 6, it is possible to protect the inverter circuit from the fuel.

In the present embodiment, a portion (the hatched portion 38 in FIG. 4) of the fuel tank 3 located inside the casing 2 is formed to have a greater plate thickness than other portions.

Thus, the fuel tank 3 can be regarded as a part of a frame of the casing 2, thereby simplifying the frame structure. Also, the heat of the inverter case 6 and the heat of the high temperature air in the casing 2 can be efficiently transferred to the entire fuel tank 3.

Further, in the present embodiment, among the portions of the fuel tank 3 located inside the casing 2, the portion which is not in contact with the inverter case 6 contacts the high temperature air in the casing 2, and the heat of the air is also easily dissipated to the outside through the fuel tank 3. Therefore, since it is possible to decrease the temperature of air to be taken into the engine 4 and increase the density of oxygen molecules in the air, the fuel combustion efficiency in the engine 4 can be improved, and the power generation efficiency can be improved.

In first embodiment described above, although the gutter 37 is provided at a portion of the fuel tank 3 located inside the casing 2, a gutter may also be provided at a portion exposed to the outside of the casing 2 so as to guide the fuel not to flow to the operation panel 11.

The gutter 37 may not be provided if the fuel does not flow to the inverter case 6 and to the operation panel 11.

Next, a second embodiment of the present invention will be described.

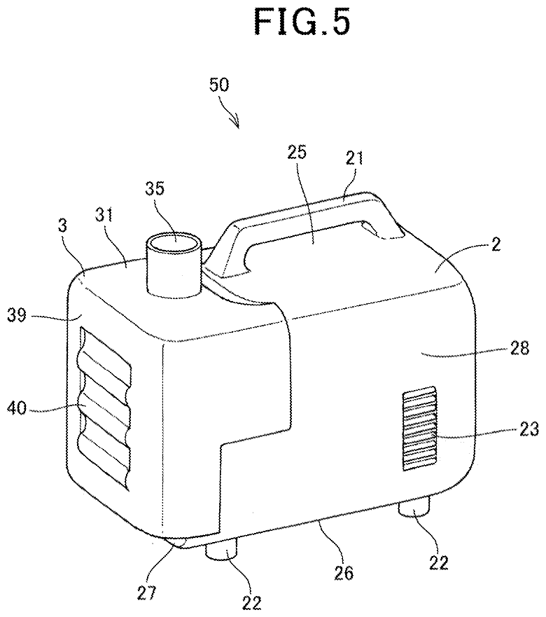

FIG. 5 is a perspective view showing the appearance of a power generator of the second embodiment.

A power generator 50 of the second embodiment is the power generator 1 of the first embodiment (see FIG. 1), but has recesses and protrusions 40 formed on the front plate 39 located outside the casing 2 of the fuel tank 3. Other portions are the same as in the first embodiment described above.

Thus, in the second embodiment, the recesses and protrusions 40 are formed at a portion of the fuel tank 3 located outside the casing 2.

Consequently, the surface area of the fuel tank 3 can be increased, and the heat dissipation efficiency can be improved. Moreover, since the recesses and protrusions 40 are formed at a portion of the fuel tank 3 located outside the casing 2, it is also possible to improve the design.

Further, in the second embodiment, if the fuel tank 3 is made of metal, it is possible to easily form the recesses and protrusions 40. In particular, if the plate thickness of the recesses and protrusions 40 is thin, not only the recesses and protrusions 40 are easily formed, but also the surface area of the fuel tank 3 can be increased, and therefore it is possible to further improve the heat dissipation efficiency.

In the second embodiment, although the recesses and protrusions 40 are formed on the front plate 39 located outside the casing 2 of the fuel tank 3, the recesses and protrusions 40 may be formed on the side plate 32 of the fuel tank 3 located outside the casing 2, or on the top plate 31. In this case, it is also possible to improve the heat dissipation efficiency by increasing the surface area of the fuel tank 3, and it is also possible to improve the design.

Also, the recesses and protrusions 40 may be formed at a portion of the fuel tank 3 located inside the casing 2. In this case, the surface area of the fuel tank 3 can also be increased, and the heat dissipation efficiency can be improved by bringing the air taken from the outside of the casing 2 into contact with the recesses and protrusions 40 in the inside.

In each of the above-described embodiments, examples in which a part of the fuel tank 3 is exposed to the outside of the casing 2 are described, but the present invention is not limited to these examples. For example, the entire fuel tank 3 may also be housed inside the casing 2.

Even in this case, by forming the inverter case 6 and the fuel tank 3 with a material having high thermal conductivity, the fuel tank 3 can function as a heat sink for dissipation of heat in the inverter case 6, and it is possible to prevent a rise in the temperature of the inverter case 6.

In each of the embodiments, the inverter case 6 is integrated with the fuel tank 3 at the second recessed portion 36 in the lower portion of the fuel tank 3, but the second recessed portion 36 may not be formed, or the inverter case 6 may not be integrated with the fuel tank 3, as long as the inverter case 6 is in contact with the fuel tank 3.

Further, in each of the embodiments, a portion of the fuel tank 3 located inside the casing 2 of the fuel tank 3 is formed to have a greater plate thickness than other portions, but even if not, the intended purpose of efficiently dissipating the heat of the inverter case 6 can be achieved.

The above-described embodiments are merely examples of an aspect of the present invention, and any modification and application can be made within a range not departing from the gist of the present invention.

### REFERENCE SIGNS LIST

1, 50 power generator

2 casing

3 fuel tank

4 engine

5 alternator

6 inverter case

36 second recessed portion

37 gutter

40 recesses and protrusions

What is claimed is:

1. A power generator comprising: an alternator for generating electricity by driving an engine; an inverter case containing an inverter circuit of the alternator; a fuel tank for storing a fuel to be supplied to the engine; and a casing for housing at least the engine, the alternator and the inverter case, wherein
the inverter case and the fuel tank are formed of a material having higher thermal conductivity than the casing, and the inverter case is disposed in contact with the fuel tank.

2. The power generator according to claim 1, wherein at least a part of the fuel tank is exposed to outside of the casing.

3. The power generator according to claim 1, wherein a recessed portion is formed at a lower portion of the fuel tank, and the inverter case is disposed in the recessed portion.

4. The power generator according to claim 1, wherein a gutter for guiding the fuel not to flow into the inverter case is provided at a portion of the fuel tank located inside the casing.

5. The power generator according to claim 1, wherein a portion of the fuel tank located inside the casing is formed to have a greater plate thickness than other portions.

6. The power generator according to claim 1, wherein a recess and a protrusion are formed at a portion of the fuel tank located outside the casing.
